(19) United States
(12) Patent Application Publication
(10) Pub. No.: US 2008/0232237 A1
(43) Pub. Date: Sep. 25, 2008

(54) METHOD AND APPARATUS FOR ROBUST TIMING RECOVERY OF OFDM SYSTEM FOR FAST FADING CHANNELS

(75) Inventor: Qin Liu, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/687,686

(22) Filed: Mar. 19, 2007

(51) Int. Cl. H04J 11/00

(52) U.S. Cl. 370/208

(57) ABSTRACT

In an orthogonal frequency division multiplex (OFDM) communication system, a method comprising the step of performing time estimation in a time domain.

### FIELD OF THE INVENTION

The present invention relates generally to timing recovery or sampling-clock synchronization for fast fading channels, more specifically the present invention relates to timing recovery based on channel profile.

### BACKGROUND

Timing recovery is needed in digital receiver in order to synchronize the receiver to the transmitter clock as receiver uses local clock. For various reasons such as the oscillators' imperfections, the clocks at the transmitter side and at the receiver side are not synchronized. At the receiver side, the sampling clock needs to be adjusted. On the other hand, the received signal typical is from multiple reflectors exhibiting multi-path effects. Traditional timing recovery for orthogonal frequency division multiplex (OFDM) system is done in the frequency domain (so called post-FFT). This traditional method has the disadvantage of performance degradation under fast fading channels. There is a need to look at the problem in the time domain.

### SUMMARY OF THE INVENTION

In an OFDM system, a method for timing recovery in the timing domain is provided.

In an orthogonal frequency division multiplex (OFDM) communication system, a method comprising the step of performing time estimation in a time domain.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a conventional STR (symbol timing recovery) for an OFDM system.

FIG. 2 is an example of a block diagram of STR in accordance with some embodiments of the invention.

FIG. 3 is an example of a STR on a frame by frame basis in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to STR in the time domain for an OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of STR in the time domain for an OFDM system described herein. The non-processor circuits may include, but are not limited to, a radio receiver, a radio transmitter, signal drivers, clock circuits, power source circuits, and user input devices. As such, these functions may be interpreted as steps of a method to perform STR in the time domain for an OFDM system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

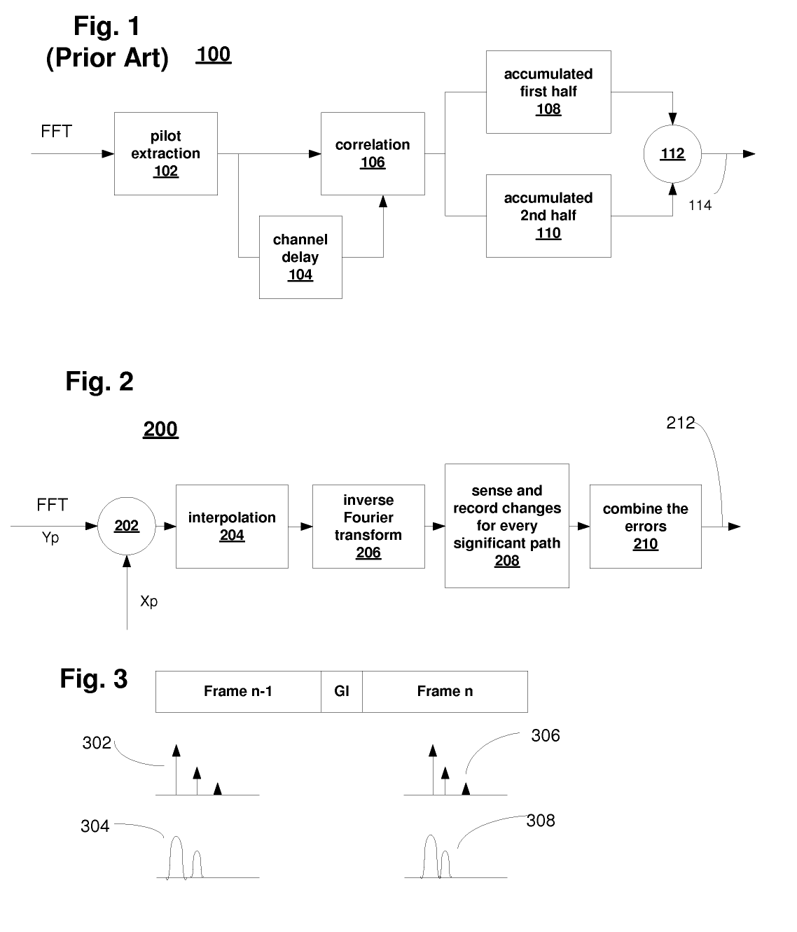

Referring to FIGS. 1-3, depictions regarding the present invention are shown. In FIG. 1, a known timing estimation in the frequency domain is shown. Upon fast Fourier transform (FFT), the symbols are now in the frequency domain. The symbol first goes through pilot subtraction 102 such as continuous pilot extraction. The resultant data go through correlation 106, and a frame delay. The transformed, correlated data tend to accumulate in two sets with a first set accumulating about a first half of a frequency segment 108 and a second half accumulating about a second half of the frequency segment 110. The outputs of accumulator 108 and accumulator 110 are subjected to an algebraic summation by summer 112 resulting in a frequency domain timing estimation.

In FIG. 2, a system 200 for time estimate in the time domain is shown. Currently received pilot symbol characteristic Yp is compared with a prior pilot symbol characteristic Xp at comparator 202. The compared pilot characteristics go through interpolation 204 to derive a set of estimations on the rest of the points. The recovered symbol is transformed into time domain by inverse Fourier transform 206 such as an Inverse Fast Fourier Transform (IFFT).

The recovered symbol block 208, wherein for every significant path, the changes or differences between symbols or frames are read and recorded. The changes detected using ordinary timing error detectors. By way of example, in FIG. 3, frame or symbol n−1 and frame n are interposed by a guard interval (GI). Frame n is currently being processed and the path characteristics at frame n−1 are known. The path characteristics include the relative strength and position of a predetermined point. Three such points are shown in 302. In practice, the signals associated with the points are not that clean in that merely curves 304 can be detected by suitable detection means. The relative strength and position of a set predetermined points 306 associated with frame n theoretically are used to determine the path characteristics. Curves 304 associated with frame n−1 are used as a reference for the curves 308 associated with frame n.

In a TDS-OFDM system, wherein time domain information is readily available and pilot extraction is not required, the time estimation can start directly at block 208. In other words, the steps in blocks 202-206 are not needed in that data in the time domain free of pilots already exist. In a TDS-OFDM system, PNs are disposed between the OFDM symbols. The present invention contemplates using the PN sequence disclosed in U.S. Pat. No. 7,072,289 to Yang et al which is hereby incorporated herein by reference.

The characteristics of the subject channel are combined in block 210 to derive a time estimation in the time domain.

After time-domain channel estimation is obtained, multipaths with relatively bigger amplitudes can be tracked, i.e. by comparing the relative peak change and combining the characteristics relating to the symbols, a more robust estimate is achieved.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In an orthogonal frequency division multiplex (OFDM) communication system, a method comprising the step of performing time estimation in a time domain.

2. The method of claim 1, wherein the OFDM communication system comprises a TDS-OFDM communication system.

3. The method of claim 1, wherein the step of performing time estimation comprises tracking multipaths with relatively bigger amplitudes.

4. The method of claim 1, wherein the step of performing time estimation comprises comparing at least one relative peak changes and combining the changes, thereby obtaining a more robust estimate.
